(19) United States
(12) Patent Application Publication
(10) Pub. No.: US 2018/0324103 A1
(43) Pub. Date: Nov. 8, 2018

(54) CROSS-CARRIER TRANSPORT BLOCK DECODING ORDER INDICATION

(71) Applicant: QUALCOMM Incorporated, San Diego, CA (US)

(72) Inventors: Yue YANG, San Diego, CA (US); Aziz GHOLMIEH, Del Mar, CA (US); Shailesh MAHESHWARI, San Diego, CA (US); Vishal DALMIYA, San Diego, CA (US)

(21) Appl. No.: 15/913,301

(22) Filed: Mar. 6, 2018

Related U.S. Application Data
(60) Provisional application No. 62/501,576, filed on May 4, 2017.

(51) Int. Cl. H04L 12/801; H04W 72/14; H04W 76/27; H04W 72/04

(52) U.S. Cl. CPC H04L 47/34; H04W 72/0453; H04W 76/27; H04W 72/14

(57) ABSTRACT

Certain aspects of the present disclosure relate to methods and apparatus for component carrier and/or transport block decoding order indication to reduce packet data convergence protocol (PDCP) reordering. For example, the method generally includes generating an ordered sequence of packets associated with a plurality of transport blocks for transmission to a receiving device. The method includes providing an indication to the receiving device of the ordered sequence of packets associated with the plurality of transport blocks. The method includes transmitting the plurality of transport blocks to the receiving device. The receiving device decodes the plurality of transport blocks in accordance with the indication.

### CROSS-REFERENCE TO RELATED APPLICATION & PRIORITY CLAIM

This application claims benefit of and priority to U.S. Provisional Patent Application Ser. No. 62/501,576, filed May 4, 2017, which is herein incorporated by reference in its entirety for all applicable purposes.

### TECHNICAL FIELD

The present disclosure relates generally to communication systems, and more particularly, to methods and apparatus for wireless communication including, for example, a packet sequence or decoding order indication to reduce packet data convergence protocol (PDCP) reordering overhead for certain systems, such as carrier aggregation (CA) systems.

### INTRODUCTION

Wireless communication systems are widely deployed to provide various telecommunication services such as telephony, video, data, messaging, broadcasts, etc. These systems may employ multiple-access technologies capable of supporting communication with multiple users by sharing available system resources (e.g., bandwidth and transmit power). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In some examples, a wireless multiple-access communication system may include a number of base stations (BSs) that each can simultaneously support communication for multiple communication devices, otherwise known as user equipment (UEs). In LTE or LTE-A network, a set of one or more BSs may define an eNodeB (eNB). In other examples (e.g., in a next generation, new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node, a NR BS, a NR NB, a network node, a 5G NB, an eNB, a Next Generation Node B (gNB), etc. A BS or DU may communicate with a set of UEs on downlink channels (e.g., for transmissions from a BS or to a UE) and uplink channels (e.g., for transmissions from a UE to a BS or DU).

These multiple access technologies have been adopted in various telecommunication standards to provide a common protocol that enables different wireless devices to communicate on a municipal, national, regional, and even global level. NR (e.g., 5G radio access) is an example of an emerging telecommunication standard is. NR is a set of enhancements to the LTE mobile standard promulgated by 3GPP. It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL) as well as support beamforming, multiple-input multiple-output (MIMO) antenna technology, and carrier aggregation.

However, as the demand for mobile broadband access continues to increase, there exists a desire for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Aspects of the present disclosure relate to a packet sequence or decoding order indication to reduce packet data convergence protocol (PDCP) reordering overhead for certain systems, such as carrier aggregation (CA) systems.

Certain aspects provide a method for wireless communication that can be performed by a transmitting device (e.g., a base station). The method generally includes generating an ordered sequence of packets associated with a plurality of transport blocks (TBs) for transmission to a receiving device. The transmitting device provides an indication to the receiving device of the ordered sequence associated with the plurality of TBs and transmits the plurality of TBs to the receiving device.

Certain aspects provide a method for wireless communication that can be performed by a receiving device (e.g., a user equipment). The method generally includes receiving an indication from a transmitting device of an ordered sequence of packets associated with a plurality of TBs. The receiving device receives the plurality of TBs from the transmitting device and decodes the plurality of TBs in accordance with the indication.

Certain aspects provide an apparatus for wireless communication such as a transmitting device (e.g., a BS). The apparatus generally includes means for generating an ordered sequence of packets associated with a plurality of TBs for transmission to a receiving device. The apparatus includes means for providing an indication to the receiving device of the ordered sequence associated with the plurality of TBs and means for transmitting the plurality of TBs to the receiving device.

Certain aspects provide an apparatus for wireless communication such as a receiving device (e.g., a UE). The apparatus generally includes means for receiving an indication from a transmitting device of an ordered sequence of packets associated with a plurality of TBs. The apparatus includes means for receiving the plurality of TBs from the transmitting device and means for decoding the plurality of TBs in accordance with the indication.

Certain aspects provide an apparatus for wireless communication such as a transmitting device (e.g., a BS). The apparatus generally includes at least one processor coupled with a memory and configured to generate an ordered sequence of packets associated with a plurality of TBs for transmission to a receiving device. The apparatus includes a transmitter configured to provide an indication to the receiving device of the ordered sequence associated with the plurality of TBs and transmit the plurality of TBs to the receiving device.

Certain aspects provide an apparatus for wireless communication such as a receiving device (e.g., a UE). The apparatus generally includes a receiver configured to receive an indication from a transmitting device of an ordered sequence of packets associated with a plurality of TBs and receive the plurality of TBs from the transmitting device. The apparatus includes at least one processor coupled with a memory and configured to decode the plurality of TBs in accordance with the indication.

Certain aspects provide a computer readable medium having computer executable code stored thereon for wireless communication. The computer executable code generally includes code for generating an ordered sequence of packets associated with a plurality of TBs for transmission to a receiving device. The computer executable code includes code for providing an indication to the receiving device of the ordered sequence associated with the plurality of TBs and code for transmitting the plurality of TBs to the receiving device.

Certain aspects provide a computer readable medium having computer executable code stored thereon for wireless communication. The computer executable code generally includes code for receiving an indication from a transmitting device of an ordered sequence of packets associated with a plurality of TBs. The computer executable code includes code for receiving the plurality of TBs from the transmitting device and code for decoding the plurality of TBs in accordance with the indication.

Aspects generally include methods, apparatus, systems, computer readable mediums, and processing systems, as substantially described herein with reference to and as illustrated by the accompanying drawings.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIG. 5 is a diagram showing examples for implementing a communication protocol stack, in accordance with certain aspects of the present disclosure.

FIG. 6 illustrates an example of a downlink centric slot, in accordance with certain aspects of the present disclosure.

FIG. 7 illustrates an example of an uplink centric slot, in accordance with certain aspects of the present disclosure.

FIG. 8 illustrates an example contiguous carrier aggregation type, according to aspects of the present disclosure.

FIG. 9 illustrates an example non-contiguous carrier aggregation type, according to aspects of the present disclosure.

FIG. 10 is a flow diagram illustrating example operations for wireless communications by a transmitting device, in accordance with aspects of the present disclosure.

FIG. 11 is a flow diagram illustrating example operations for wireless communications by a receiving device, in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for NR (new radio access technology or 5G technology). NR may support various wireless communication services, such as enhanced mobile broadband (eMBB) targeting wide bandwidth (e.g. 80 MHz or beyond), millimeter wave (mmW) targeting high carrier frequency (e.g. 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

A receiving device typically has no information about the sequence of transport blocks (TBs) from a transmitting device and decodes the TBs in the order they are received. In some cases, the order of the TBs may not correspond to the ordered sequence of the associated packets. Thus, the TBs or packets may be received and/or decoded out-of-order. The receiving device may need to re-order the packets before delivering them to the upper layer. In carrier aggregation (CA), the TBs can be received on different CAs, sometimes in the same transmission time interval (TTI), further complicating the decoding order and adding to the re-ordering overhead.

Aspects of the present disclosure provide a packet sequence or decoding order indication to reduce the reordering overhead for certain systems including CA systems

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication networks such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). NR is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). “LTE” refers generally to LTE, LTE-Advanced (LTE-A), LTE in an unlicensed spectrum (LTE-whitespace), etc. The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

### Example Wireless Communications System

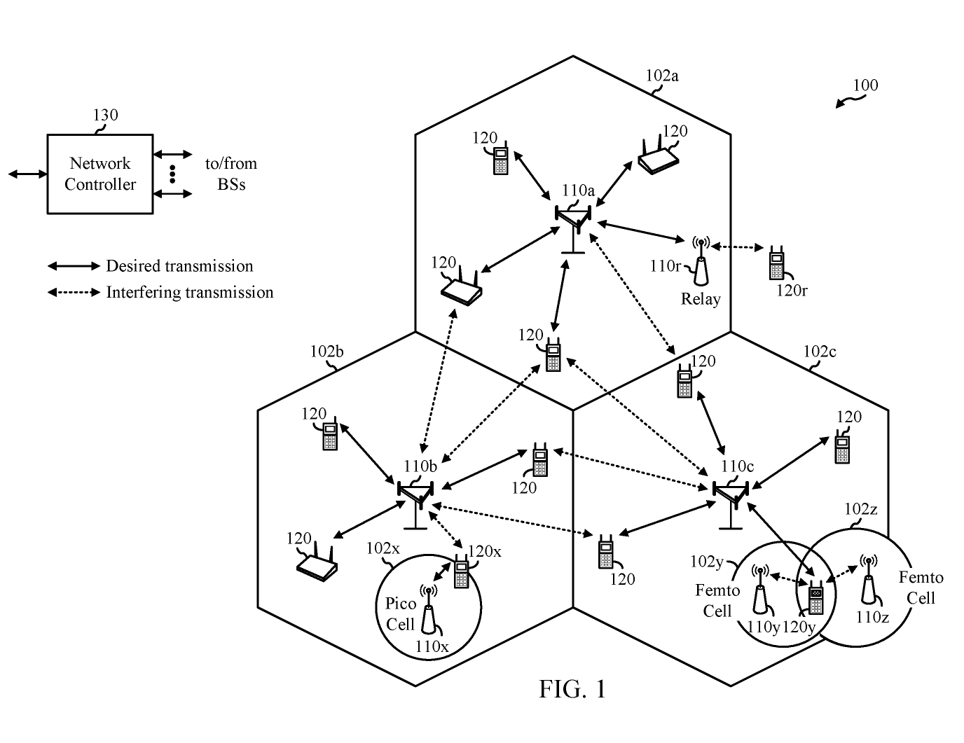

FIG. 1 illustrates an example wireless network 100, such as a new radio (NR) or 5G network, in which aspects of the present disclosure may be performed. The wireless network 100 may support carrier aggregation (CA). As illustrated in FIG. 1, the wireless network 100 may include a number of BSs 110 and other network entities. A BS may be a station that communicates with user equipment (UEs) 120. The BS 110 generates an ordered sequence of packets associated with a plurality of transport blocks for transmission to a UE 120. The BS 110 can provide an indication to the UE 120 of the ordered sequence of packets associated with the TBs and transmits the TBs to the UE 120. The UE 120 receives the TBs and the indication and decodes (e.g., at layer 2 processing) the TBs according to the indication.

Each BS 110 may provide communication coverage for a particular geographic area. In 3GPP, the term “cell” can refer to a coverage area of a Node B and/or a NB subsystem serving this coverage area, depending on the context in which the term is used. In NR systems, the term “cell” and NB, evolved NB (eNB), 5G NB, next generation NB (gNB), access point (AP), BS, NR BS, or transmission reception point (TRP) may be interchangeable. In some examples, a cell may not necessarily be stationary, and the geographic area of the cell may move according to the location of a mobile base station. In some examples, the BSs may be interconnected to one another and/or to one or more other BSs or network nodes (not shown) in the wireless network 100 through various types of backhaul interfaces such as a direct physical connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a frequency channel, a tone, a subband, a subcarrier, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BS for the femto cells 102y and 102z, respectively. A BS may support one or multiple (e.g., three) cells.

The wireless network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

The wireless network 100 may be a heterogeneous network that includes BSs of different types, e.g., macro BS, pico BS, femto BS, relays, etc. These different types of BSs may have different transmit power levels, different coverage areas, and different impact on interference in the wireless network 100. For example, macro BS may have a high transmit power level (e.g., 20 Watts) whereas pico BS, femto BS, and relays may have a lower transmit power level (e.g., 1 Watt).

The wireless network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may be coupled to a set of BSs and provide coordination and control for these BSs. The network controller 130 may communicate with the BSs 110 via a backhaul. The BSs 110 may also communicate with one another, directly or indirectly, via a wireless or wireline backhaul.

The UEs 120 (e.g., 120x, 120y, etc.) may be dispersed throughout the wireless network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or medical equipment, a healthcare device, a biometric sensor/device, a wearable device such as a smart watch, smart clothing, smart glasses, virtual reality goggles, a smart wrist band, smart jewelry (e.g., a smart ring, a smart bracelet, etc.), an entertainment device (e.g., a music device, a video device, a satellite radio, etc.), a vehicular component or sensor, a smart meter/sensor, a robot, a drone, industrial manufacturing equipment, a positioning device (e.g., GPS, Beidou, terrestrial, etc.), or any other suitable device that is configured to communicate via a wireless or wired medium. Some UEs may be considered machine-type communication (MTC) devices or evolved MTC (eMTC) devices, which may include remote devices that may communicate with a base station, another remote device, or some other entity. MTC may refer to communication involving at least one remote device on at least one end of the communication and may include forms of data communication which involve one or more entities that do not necessarily need human interaction. MTC UEs may include UEs that are capable of MTC communications with MTC servers and/or other MTC devices through Public Land Mobile Networks (PLMN), for example. MTC and eMTC UEs include, for example, robots, drones, remote devices, sensors, meters, monitors, cameras, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. MTC UEs, as well as other UEs, may be implemented as Internet-of-Things (IoT) devices, which may be narrowband IoT (NB-IoT) devices.

In FIG. 1, a solid line with double arrows indicates desired transmissions between a UE and a serving BS, which is a BS designated to serve the UE on the downlink and/or uplink. A dashed line with double arrows indicates interfering transmissions between a UE and a BS.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (e.g., a resource block (RB)) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (e.g., 6 resource blocks), and there may be 1, 2, 4, 8 or 16 subbands for system bandwidth of 1.25, 2.5, 5, 10 or 20 MHz, respectively.

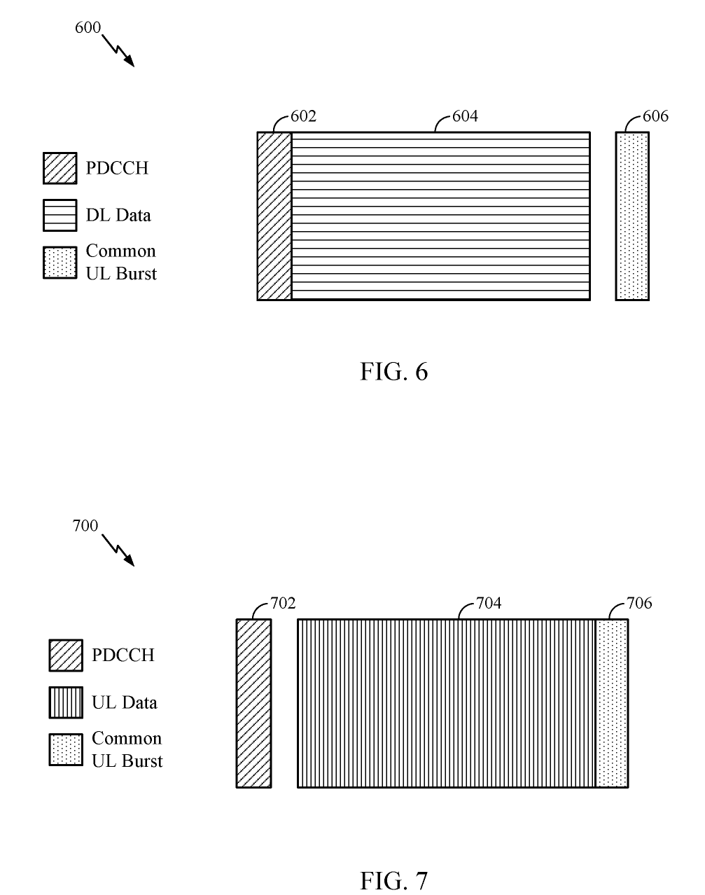

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. A single component carrier bandwidth of 100 MHz may be supported. NR RBs may span 12 subcarriers with a subcarrier bandwidth of 75 kHz over a 0.1 ms duration. Each radio frame may consist of two half frames, each half frame consisting of 5 subframes, with a length of 10 ms. Consequently, each subframe may have a length of 0.1 ms. Each subframe may indicate a link direction (e.g., DL or UL) for data transmission and the link direction for each subframe may be dynamically switched. Each subframe may include DL/UL data as well as DL/UL control data. UL and DL subframes for NR may be as described in more detail below with respect to FIGS. 6 and 7. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In LTE, the basic transmission time interval (TTI) or packet duration is the 1 subframe. In NR, a subframe is still 1 ms, but the basic TTI is referred to as a slot. A subframe contains a variable number of slots (e.g., 1, 2, 4, 8, 16, . . . slots) depending on the tone-spacing (e.g., 15, 30, 60, 120, 240 . . . kHz).

In some examples, access to the air interface may be scheduled, wherein a scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. BSs are not the only entities that may function as a scheduling entity. In some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

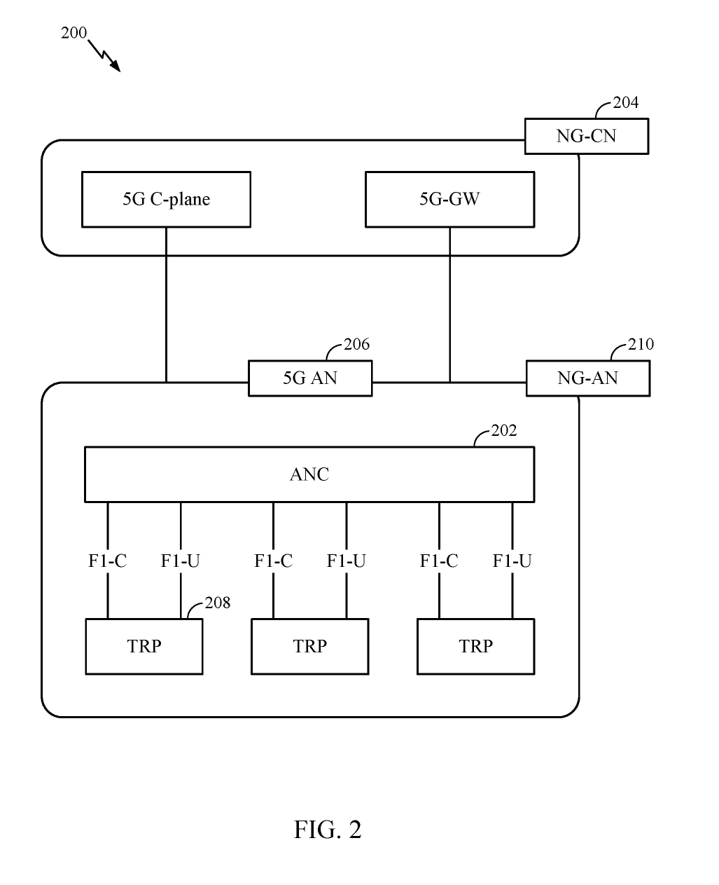

FIG. 2 illustrates an example logical architecture of a distributed radio access network (RAN) 200, which may be implemented in the wireless communication system illustrated in FIG. 1. A 5G access node 206 may include an access node controller (ANC) 202. The ANC 202 may be a central unit (CU) of the distributed RAN 200. The backhaul interface to the next generation core network (NG-CN) 204 may terminate at the ANC 202. The backhaul interface to neighboring next generation access nodes (NG-ANs) may terminate at the ANC 202. The ANC 202 may include one or more TRPs 208 (which may also be referred to as BSs, gNBs, or some other term).

The TRPs 208 may be a DU. The TRPs 208 may be connected to one ANC (ANC 202) or more than one ANC (not illustrated). For example, for RAN sharing, radio as a service (RaaS), and service specific AND deployments, the TRP 208 may be connected to more than one ANC. A TRP may include one or more antenna ports. The TRPs may be configured to individually (e.g., dynamic selection) or jointly (e.g., joint transmission) serve traffic to a UE.

The logical architecture of the distributed RAN 200 may support fronthauling solutions across different deployment types. For example, the logical architecture may be based on transmit network capabilities (e.g., bandwidth, latency, and/or jitter). The logical architecture may share features and/or components with LTE. The NG-AN 210 may support dual connectivity with NR. The NG-AN 210 may share a common fronthaul for LTE and NR.

The logical architecture may enable cooperation between and among TRPs 208. For example, cooperation may be within a TRP and/or across TRPs via the ANC 202. An inter-TRP interface may not be present.

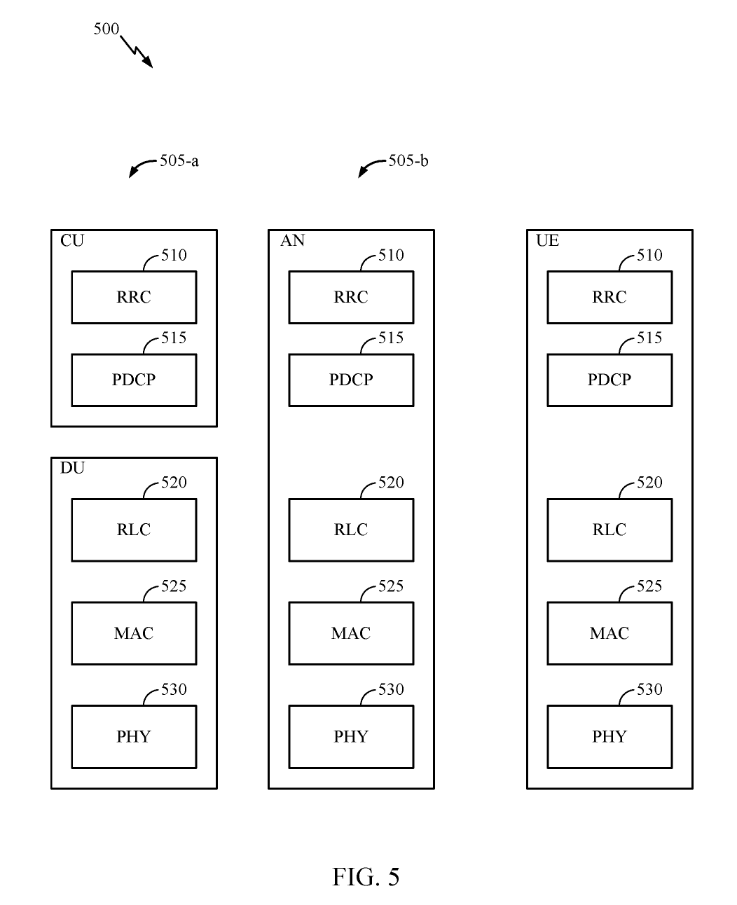

The logical architecture of the distributed RAN 200 may have a dynamic configuration of split logical functions. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU or CU (e.g., TRP or ANC, respectively).

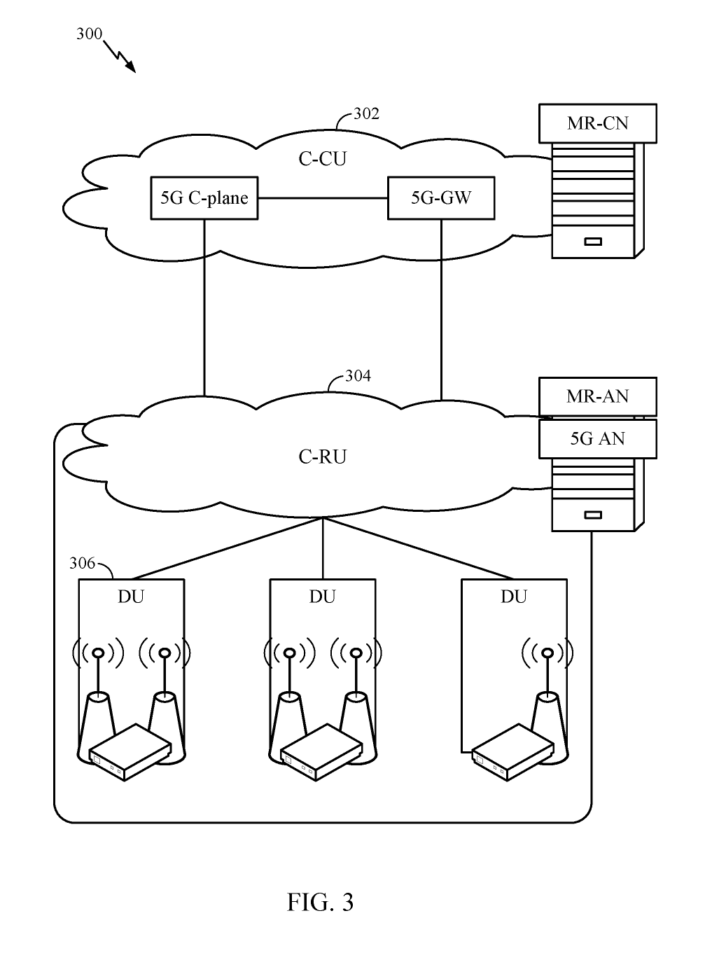

FIG. 3 illustrates an example physical architecture of a distributed RAN 300, according to aspects of the present disclosure. A centralized core network unit (C-CU) 302 may host core network functions. The C-CU 302 may be centrally deployed. C-CU functionality may be offloaded (e.g., to advanced wireless services (AWS)), in an effort to handle peak capacity. A centralized RAN unit (C-RU) 304 may host one or more ANC functions. The C-RU 304 may host core network functions locally. The C-RU 304 may have distributed deployment. The C-RU 304 may be near the network edge. A DU 306 may host one or more TRPs (edge node (EN), an edge unit (EU), a radio head (RH), a smart radio head (SRH), or the like). The DU 306 may be located at edges of the network with radio frequency (RF) functionality.

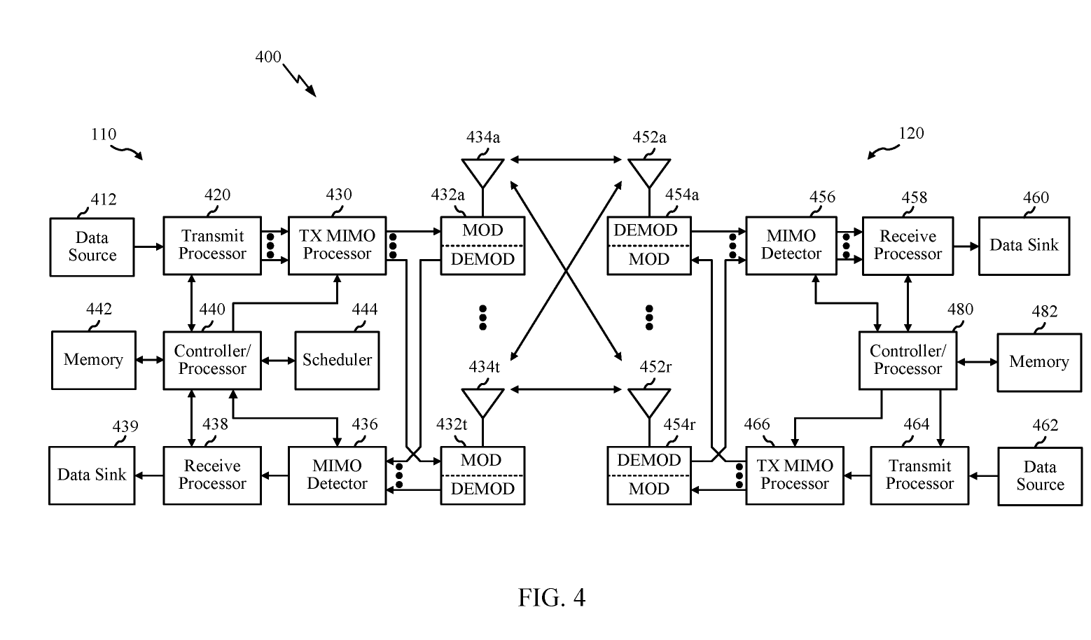

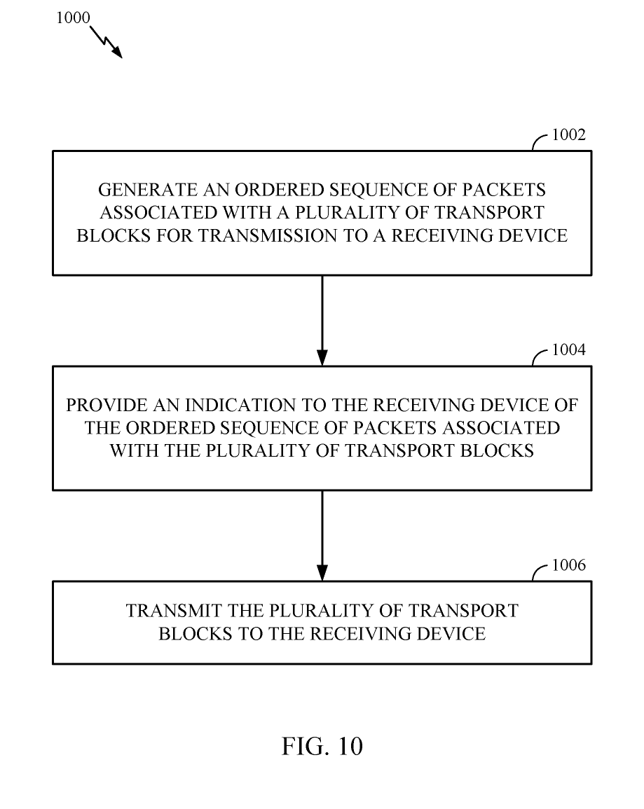

FIG. 4 illustrates example components of the BS 110 (which may be a gNB) and UE 120 illustrated in FIG. 1, which may be used to implement aspects of the present disclosure for a cross-carrier ordered packet sequence or decoding order indication. For example, antennas 452, Tx/Rx 222, processors 466, 458, 464, and/or controller/processor 480 of the UE 120 and/or antennas 434, processors 460, 420, 438, and/or controller/processor 440 of the BS 110 may be used to perform the operations described herein and illustrated with reference to FIG. 10.

At BS 110, a transmit processor 420 may receive data from a data source 412 and control information from a controller/processor 440. The control information may be for the Physical Broadcast Channel (PBCH), Physical Control Format Indicator Channel (PCFICH), Physical Hybrid ARQ Indicator Channel (PHICH), Physical Downlink Control Channel (PDCCH), etc. The data may be for the Physical Downlink Shared Channel (PDSCH), etc. The processor 420 may process (e.g., encode and symbol map) the data and control information to obtain data symbols and control symbols, respectively. The processor 420 may also generate reference symbols, e.g., for the PSS, SSS, and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively. For example, the ordered packet sequence or decoding order indication can be provided as well as the transport blocks associated with the indication.

At the UE 120, the antennas 452a through 452r may receive the downlink signals from the BS 110 and may provide received signals to the demodulators (DEMODs) 454a through 454r, respectively. For example, the UE 120 may receive the ordered packet sequence or decoding order indication as well as the transport blocks associated with the indication from the BS 110. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480. The UE 120 may perform layer 2 processing of the received TBs in accordance with the indication of the ordered packet sequence or decoding order from the BS 110. CoMP aspects can include providing the antennas, as well as some Tx/Rx functionalities, such that they reside in distributed units. For example, some Tx/Rx processings can be done in the central unit, while other processing can be done at the distributed units. For example, in accordance with one or more aspects as shown in the diagram, the BS mod/demod 432 may be in the distributed units.

On the uplink, at the UE 120, a transmit processor 464 may receive and process data (e.g., for the Physical Uplink Shared Channel (PUSCH)) from a data source 462 and control information (e.g., for the Physical Uplink Control Channel (PUCCH) from the controller/processor 480. The transmit processor 464 may also generate reference symbols for a reference signal. The symbols from the transmit processor 464 may be precoded by a TX MIMO processor 466 if applicable, further processed by the demodulators 454a through 454r (e.g., for SC-FDM, etc.), and transmitted to the BS 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

The controllers/processors 440 and 480 may direct the operation at the BS 110 and the UE 120, respectively. The processor 440 and/or other processors and modules at the BS 110 may perform or direct the processes for the techniques described herein. The processor 480 and/or other processors and modules at the UE 120 may also perform or direct processes for the techniques described herein. The memories 442 and 482 may store data and program codes for the BS 110 and the UE 120, respectively. A scheduler 444 may schedule UEs for data transmission on the downlink and/or uplink.

FIG. 5 illustrates a diagram 500 showing examples for implementing a communications protocol stack, according to aspects of the present disclosure. The illustrated communications protocol stacks may be implemented by devices operating in a in a 5G system (e.g., a system that supports uplink-based mobility). Diagram 500 illustrates a communications protocol stack including a Radio Resource Control (RRC) layer 510, a Packet Data Convergence Protocol (PDCP) layer 515, a Radio Link Control (RLC) layer 520, a Medium Access Control (MAC) layer 525, and a Physical (PHY) layer 530. In various examples the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., TRP 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples the CU and the DU may be collocated or non-collocated. The first option 505-a may be useful in a macro cell, micro cell, or pico cell deployment. A second option 505-b shows a unified implementation of a protocol stack, in which the protocol stack is implemented in a single network access device. In the second option, the RRC layer 510, the PDCP layer 515, the RLC layer 520, the MAC layer 525, and the PHY layer 530 may each be implemented by the AN. The second option 505-b may be useful in a femto cell deployment. Regardless of whether a network access device implements part or all of a protocol stack, a UE may implement an entire protocol stack (e.g., the RRC layer 510, the PDCP layer 515, the RLC layer 520, the MAC layer 525, and the PHY layer 530).

FIG. 6 is a diagram showing an example of a downlink-centric subframe 600. The DL-centric subframe 600 may include a control portion 602. The control portion 602 may exist in the initial or beginning portion of the DL-centric subframe 600. The control portion 602 may include various scheduling information and/or control information corresponding to various portions of the DL-centric subframe 600. In some configurations, the control portion 602 may be a physical DL control channel (PDCCH), as shown in FIG. 6. The DL-centric subframe 600 may also include a DL data portion 604. The DL data portion 604 may be referred to as the payload of the DL-centric subframe 600. The DL data portion 604 may include the communication resources utilized to communicate DL data from the scheduling entity (e.g., UE or BS) to the subordinate entity (e.g., UE). In some configurations, the DL data portion 604 may be a physical DL shared channel (PDSCH).

The DL-centric subframe 600 may also include a common UL portion 606. The common UL portion 606 may be referred to as an UL burst, a common UL burst, and/or various other suitable terms. The common UL portion 606 may include feedback information corresponding to various other portions of the DL-centric subframe 600. For example, the common UL portion 606 may include feedback information corresponding to the control portion 602. Non-limiting examples of feedback information may include an ACK signal, a NACK signal, a HARQ indicator, and/or various other suitable types of information. The common UL portion 606 may include additional or alternative information, such as information pertaining to random access channel (RACH) procedures, scheduling requests (SRs), and various other suitable types of information. As illustrated in FIG. 6, the end of the DL data portion 604 may be separated in time from the beginning of the common UL portion 606. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). The foregoing is merely one example of a DL-centric subframe and alternative structures having similar features may exist without necessarily deviating from the aspects described herein.

FIG. 7 is a diagram showing an example of an uplink-centric subframe 700. The UL-centric subframe 700 may include a control portion 702. The control portion 702 may exist in the initial or beginning portion of the UL-centric subframe 700. The control portion 702 in FIG. 7 may be similar to the control portion 602 described above with reference to FIG. 6. The UL-centric subframe 700 may also include an UL data portion 704. The UL data portion 704 may be referred to as the payload of the UL-centric subframe 700. The UL portion may refer to the communication resources utilized to communicate UL data from the subordinate entity (e.g., UE) to the scheduling entity (e.g., UE or BS). In some configurations, the control portion 702 may be a PDCCH.

As illustrated in FIG. 7, the end of the control portion 702 may be separated in time from the beginning of the UL data portion 704. This time separation may be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe 700 may also include a common UL portion 706. The common UL portion 706 in FIG. 7 may be similar to the common UL portion 606 described above with reference to FIG. 6. The common UL portion 706 may include additional or alternative information pertaining to channel quality indicator (CQI), sounding reference signals (SRSs), and various other suitable types of information. The foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

### Example Carrier Aggregation

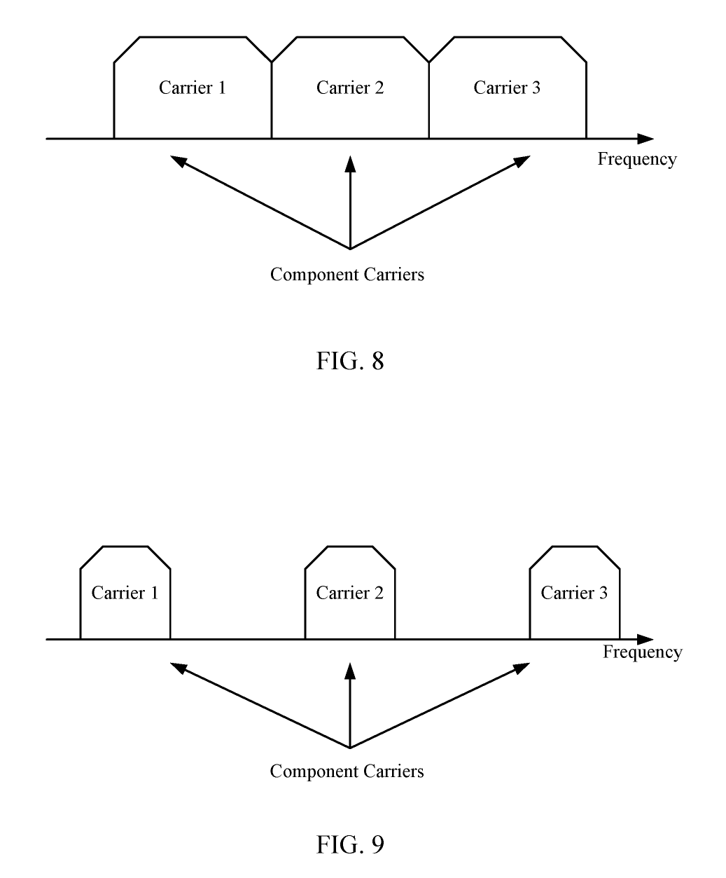

In certain systems, carrier aggregation (CA) is supported. In some examples, UEs may use spectrum of up to 20 MHz bandwidths allocated for a carrier up to a total of 100 MHz (5 CCs) for transmission in each direction. Two types of carrier aggregation include contiguous CA and non-contiguous CA. In contiguous CA, multiple available CCs are adjacent to each other as shown in FIG. 8. In non-contiguous CA multiple available CCs are separated along the frequency band as shown in FIG. 9. Both non-contiguous and contiguous CA aggregate multiple CCs to serve a single UE.

In some cases, a UE operating in a multicarrier system (e.g., a system supporting CA) can be configured to aggregate certain functions of multiple carriers, such as control and feedback functions, on a single carrier, which may be referred to as the primary component carrier (PCC). The remaining associated carriers that depend on the PCC for support are referred to as the secondary component carriers (SCC).

### Example Cross-Carrier Transport Block Decoding Order Indication

As mentioned above, in certain systems (e.g., such as wireless network 100) supporting carrier aggregation (CA), multiple component carriers (CCs) can be aggregated to serve a device, for example, a user equipment (UE). Thus, a receiving device may receive packets (e.g., service data units (SDUs) or medium access control SDUs (MSDUs)) associated with a transport block (TB), or TBs, or a MAC protocol data unit (MPDU), or MPDUs, on multiple CCs.

Typically, the receiving device monitors every TB on each CC (e.g., one by one) to decode the control information (e.g., physical downlink control channel (PDCCH)) and the data (e.g., physical downlink shared channel (PDSCH). The receiving device decodes the data on each transport block in the same order that the receiving device receives the TBs.

Since the receiving device does not have any information regarding the sequence of the TBs when the transmitting device builds the data, the packets may be decoded out of order. The decoding may refer to lower layer processor, such as layer 2 processing of the packets. For example, packets 1-10 (e.g., sequence number (SN) 1-10) can be built in a TB2 while packets 11-20 are built in the TB1. In this example, since the receiving device receives TB1 before TB2, in the order they are received, the receiving device decodes packets 11-20 before the packets 1-10. As a result, the receiving device performs reordering of the packets at the packet data convergence protocol (PDCP) layer to order the packets before they are delivered to the upper layer.

The packets ordering may be further complicated in CA, where the TBs can be transmitted on multiple different CCs in the same transmission time interval (TTI). Thus, the receiving device does not know the correct order of packets received in the TBs on the different CCs in the TTI.

Therefore, techniques for providing information to the receiving device for use in performing the decoding/processing of received TBs, even on different CCs in a TTI, are desirable in order to reduce the reordering overhead.

Accordingly, techniques are provided herein for indicating/determining a packet sequence or decoding order for decoding of TBs on multiple different CCs are desirable

FIG. 10 illustrates example operations 1000 for wireless communications by a transmitting device, such as a BS (e.g., BS 110 which may be a gNB), in accordance with aspects of the present disclosure.

Operations 1000 begin, at block 1002, by generating an ordered sequence of packets (e.g., SDUs or MSDUs) associated with a plurality of TBs (e.g., PDUs or MPDUs) for transmission to a receiving device (e.g., a UE 120). For example, the packets may be an ordered sequence of m packets. The packets in the ordered sequence may have an assigned sequence number (SN) according to the ordering (e.g., SN1, SN2 . . . SNm). The transmitting device builds the packets into a number of TBs, for example, based on the number of packets and the TB size.

At block 1004, the transmitting device provides an indication (e.g., a carrier index or a preconfigured pattern) to the receiving device of the ordered sequence of packets associated with the plurality of TBs. For example, the transmitting device indicates a decoding order for the TBs that corresponds to the ordered sequence of packets. The indication may indicate the CCs, or an order of the CCs, corresponding to the TBs associated with the ordered sequence of packets. The indication can be provided before or during generation of the ordered sequence of packets. The indication can be provided via radio resource control (RRC) signaling or a MAC control element (CE).

At block 1006, the transmitting device transmits the plurality of TBs to the receiving device. In aspects, the transmitting device transmits the plurality of TBs to the receiving device on multiple different CCs (e.g., aggregated CCs using CA). The transmitting device may transmit TBs on the multiple different CCs in a same TTI. The plurality of TBs may be transmitted in a different order than the ordered sequence of the packets. As mentioned in the illustrative example above, packets 1-10 could be in TB2, while packets 11-20 are in TB1. Additionally, the TBs can be transmitted on different CCs in the same TTI. For example, the TB1 could be transmitted on CC1 and the TB2 could be transmitted on CC2. Thus, the indication provided to the UE may inform the UE of the ordered sequence of packets, order of CCs, and/or the order of the TBs for decoding (e.g., layer 2 processing).

The transmitting device may build data into various CCs and/or TBs according to various orders. In some cases, the transmitting device may build the data based on loading on the CCs.

In some examples, the transmitting device provides the indication of the order to the receiving device before building the TBs. In this case, when the transmitting device builds the TBs, it builds the TBs in accordance with indication. The transmitting may later send further indications to the receiving device to indicate to update/change the configured decoding order.

The transmitting device can further provide an indication that indicates a transport block on a first CC (e.g., the PCC) carrying a grant (e.g., a cross-carrier scheduling grant) scheduling transmission of other TBs on other CCs. The indication can be provided with the indication of the decoding order.

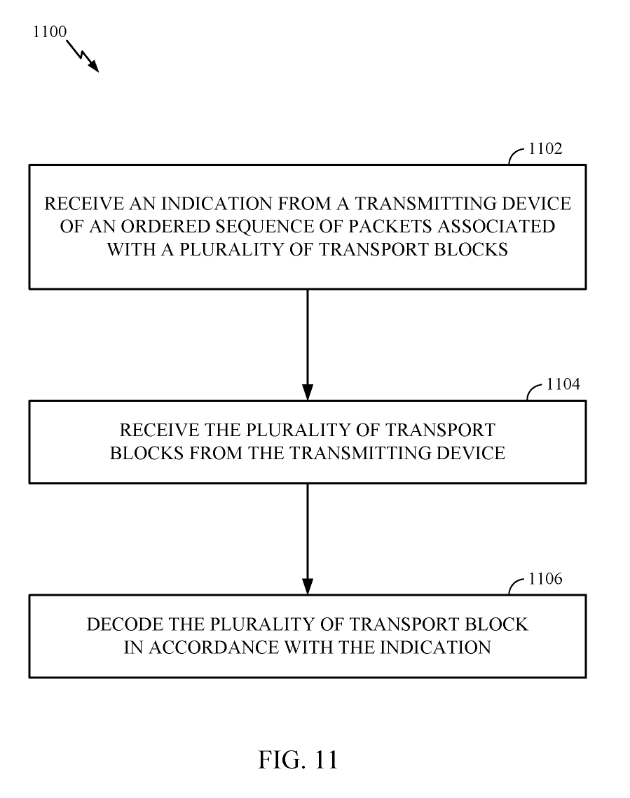

FIG. 11 illustrates example operations 1100 for wireless communications by a receiving device (e.g., UE 120), in accordance with aspects of the present disclosure. Operations 1100 may be complementary to the operations 1000 by the transmitting device.

Operations 1100 begin, at block 1102, by receiving (e.g., via RRC signaling or a MAC CE) an indication from a transmitting device of an ordered sequence of packets associated with a plurality of TBs.

At 1104, the receiving device receives the plurality of TBs from the transmitting device. Some of the TBs may be received on different CCs, and may be received on different CCs in the same TTI.

At 1106, the receiving device decodes the plurality of TBs in accordance with the indicated order. For example, the receiving device performs layer 2 processing of the plurality of TBs before sending the packets to upper layers. The TBs may be received in a different order than the indicated ordered sequence of packets. Thus, based on the indication, the receiving device may decode the TBs in a different order than the order at which the TBs are received, such that the packets are decoded according to the ordered sequence. In some cases, based on the indication, the receiving device may decode TBs received on different CCs, which may be in a same TTI, in an order such that the packets are decoded according to the ordered sequence.

According to certain aspects, the indication of the ordered sequence of packets is based on an indicated pattern. For example, a plurality of sequence/ordering patterns can be pre-defined (e.g., configured at the transmitting and receiving devices). Each pattern may correspond to a different decoding order of the CCs/TBs. For example, pattern 1 can indicate to decode the TBs in ascending (i.e., TB1, TB2, TB3 . . . ); pattern 2 can indicate to decode the TBs in descending order (i.e., TB n, TB n−1, TB n−2, . . . TB1); or other patterns. The transmitting device can provide an indication of the pattern index (e.g., via a bit) to indicate the pattern corresponding the decoding order for the ordered sequence of packets to the receiving device so that the receiving device.

According to certain aspects, the indication of the ordered sequence of packets is based on a CC index. For example, the transmitting device can indicate the set carrier indices (e.g., an ordered set) for the decoding order of those CCs corresponding to the ordered sequence of packets.

As mentioned above, the transmitting device can provide the indication of the decoding order using semi-static RRC signaling. For example, the transmitting device can provide the indication in the RRC Configuration message. After configuring/indicating the receiving device with the decoding order using the RRC signaling, the transmitting and receiving devices may use (e.g., transmit/decode) the configured/indicated order for that bearer until further RRC signaling reconfigures the decoding order.

As mentioned above, the transmitting device can provide the indication of the ordering using a MAC CE message. For example, the transmitting device can provide the indication in a MAC CE message sent before the transmission of the packets/TBs. The transmitting and receiving devices may use (e.g., transmit/decode) the configured/indicated order until another MAC CE is sent to update the ordering. In this case, the decoding sequence may be dynamically and flexibly updated.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). As used herein, including in the claims, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” For example, the articles “a” and “an” as used in this application and the appended claims should generally be construed to mean “one or more” unless specified otherwise or clear from the context to be directed to a singular form. Unless specifically stated otherwise, the term “some” refers to one or more. Moreover, the term “or” is intended to mean an inclusive “or” rather than an exclusive “or.” That is, unless specified otherwise or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1); a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, phase change memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in the appended figures.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications, comprising:
generating an ordered sequence of packets associated with a plurality of transport blocks for transmission to a receiving device;
providing an indication to the receiving device of the ordered sequence of packets associated with the plurality of transport blocks; and
transmitting the plurality of transport blocks to the receiving device.

2. The method of claim 1, wherein the indication of the ordered sequence of packets indicates a layer 2 processing order for the plurality of transport blocks corresponding to the ordered sequence of packets.

3. The method of claim 1, wherein the indicated ordered sequence of packets are associated with an order of transport blocks that is different than an order in which the plurality of transport blocks are transmitted.

4. The method of claim 1, wherein one or more of the plurality of transport blocks are transmitted to the receiving device on different component carriers using carrier aggregation.

5. The method of claim 4, wherein the one or more of the plurality of transport blocks are transmitted in a same transmission time interval (TTI).

6. The method of claim 1, further comprising:
providing an indication of a first transport block of the plurality of transport blocks on a first component carrier carrying a grant scheduling transmission of at least a second transport block of the plurality of transport blocks on at least a second component carrier.

7. The method of claim 1, wherein:
a plurality of patterns are configured for the receiving device, each pattern indicating a different ordered sequence of packets, and
the indication is provided via a bit indicating the pattern indicating the ordered sequence of packets.

8. The method of claim 1, wherein the indication comprises a set of component carrier indices indicating an order of component carriers for decoding, the order of component carriers corresponding to the ordered sequence of packets.

9. The method of claim 1, wherein the indication is provided via a radio resource control (RRC) configuration message.

10. The method of claim 1, wherein the indication is provided via a medium access control (MAC) control element.

11. A method for wireless communications, comprising:
receiving an indication from a transmitting device of an ordered sequence of packets associated with a plurality of transport blocks;
receiving the plurality of transport blocks from the transmitting device; and
decoding the plurality of transport blocks in accordance with the indication.

12. The method of claim 11, wherein decoding the plurality of transport blocks comprises layer 2 processing of the plurality of transport blocks in accordance with indication of the ordered sequence of packets associated with the plurality of transport blocks.

13. The method of claim 11, wherein the plurality of transport blocks are decoded in a different order than an order the plurality of transport blocks are received.

14. The method of claim 11, wherein one or more of the plurality of transport blocks are received on different component carriers.

15. The method of claim 14, wherein the one or more of the plurality of transport blocks are received in a same transmission time interval (TTI).

16. The method of claim 11, further comprising:
receiving an indication of a first transport block of the plurality of transport blocks on a first component carrier carrying a grant scheduling transmission of at least a second transport block of the plurality of transport blocks on at least a second component carrier.

17. The method of claim 11, wherein:
a plurality of patterns are configured, each pattern indicating a different ordered sequence of packets, and
the indication is received via a bit indicating the pattern associated with the ordered sequence associated with the plurality of transport blocks.

18. The method of 11, wherein the indication comprises a set of component carrier indices indicating an order of component carriers for decoding, the order of component carriers corresponding to the ordered sequence of packets.

19. The method of claim 11, wherein the indication is received via a radio resource control (RRC) configuration message.

20. The method of claim 11, wherein the indication is received via a medium access control (MAC) control element.

21. An apparatus for wireless communications, comprising:
means for generating an ordered sequence of packets associated with a plurality of transport blocks for transmission to a receiving device;
means for providing an indication to the receiving device of the ordered sequence of packets associated with the plurality of transport blocks; and
means for transmitting the plurality of transport blocks to the receiving device.

22. The apparatus of claim 21, wherein the indication of the ordered sequence of packets indicates a layer 2 processing order for the plurality of transport blocks corresponding to the ordered sequence of packets.

23. The apparatus of claim 21, wherein the ordered sequence of packets is different than an order in which the plurality of transport blocks are transmitted.

24. The apparatus of claim 21, wherein one or more of the plurality of transport blocks are transmitted to the receiving device on different component carriers using carrier aggregation.

25. The apparatus of claim 21, wherein the indication comprises a set of component carrier indices indicating an order of component carriers for decoding, the order of component carriers corresponding to the ordered sequence of packets.

26. An apparatus for wireless communications, comprising:
means for receiving an indication from a transmitting device of an ordered sequence of packets associated with a plurality of transport blocks;
means for receiving the plurality of transport blocks from the transmitting device; and
means for decoding the plurality of transport blocks in accordance with the indication.

27. The apparatus of claim 26, wherein decoding the plurality of transport blocks comprises layer 2 processing of the plurality of transport blocks in accordance with indication of the ordered sequence of packets associated with the plurality of transport blocks.

28. The apparatus of claim 26, wherein the plurality of transport blocks are decoded in a different order than an order the plurality of transport blocks are received.

29. The apparatus of claim 26, wherein one or more of the plurality of transport blocks are received on different component carriers.

30. The apparatus of 26, wherein the indication comprises a set of component carrier indices indicating an order of component carriers for decoding, the order of component carriers corresponding to the ordered sequence of packets.
